(19) United States
(12) Patent Application Publication
(10) Pub. No.: US 2016/0333589 A1
(43) Pub. Date: Nov. 17, 2016

(54) GUTTER HANGERS

(71) Applicant: Paul Zondlak, Standish, MI (US)

(72) Inventor: Paul Zondlak, Standish, MI (US)

(21) Appl. No.: 15/174,025

(22) Filed: Jun. 6, 2016

Related U.S. Application Data
(63) Continuation of application No. 14/713,501, filed on May 15, 2015.

(51) Int. Cl. E04D 13/072; F16M 13/02

(52) U.S. Cl. CPC E04D 13/0722; F16M 13/02

(57) ABSTRACT

Hangers for gutters that prevent the passage of water to the internal components of the hangers and prevents passage of water to wood fascia and the fasteners by which gutters are normally fastened.

This application is a Continuation-in-Part of U.S. Utility patent application Ser. No. 14/713,501, filed May 15, 2015 from which priority is claimed.

### BACKGROUND OF THE DISCLOSURE

This invention relates to a gutter hanger that is significantly improved over the state of the art gutter hangers that are available commercially.

One such gutter hanger can be found in U.S. Pat. No. 7,494,095, issued to Walker, et al on Feb. 24, 2009 in which a commercial gutter hanger is disclosed.

### THE DISCLOSURE

Thus, what is disclosed herein is a hanger for gutters. The hanger comprises an elongated support member having a first end and a second end. The first end is configured to engage and hold a front end of a gutter and the second end is configured as a raised portion integrally connected to a top surface of the elongated support member.

The raised portion has a front surface having an opening in it wherein the opening is countersunk into the front surface. The opening leads to an elongated tube, the elongated tube opening at a back end of the raised portion. There is a clip surmounted on the back end which extends beyond the raised portion.

There is a fastener, the fastener having a head and a pointed tip, and a shaft in between connecting the head and the tip together. The fastener has threads along the shaft from the head to the pointed tip, the head having a flat upper surface and a dome shaped under surface.

Also disclosed is a combination of a hanger described just Supra, and a fastener, the fastener having a head, a pointed tip, and a shaft connecting the head and the tip. The fastener has threads along the shaft from the head to the pointed tip, the head having a flat upper surface and a dome shaped under surface.

In addition, there is disclosed a hanger comprising an elongated support member having a first end and a second end. The first end is configured to engage and hold a front end of a gutter. The second end is configured as an open raised portion, integrally connected to a top surface of the elongated support member.

The raised portion has a front surface having an opening in it and the second end has an opening aligned with the front wall opening.

There is an insertable tube having both ends rolled. The rolled insertable tube is located through the front surface opening and extends outwardly from there and extends to the opening in the second end, terminating at an inside wall of the second end.

There is a clip surmounted on the back end which extends beyond the raised portion. The clip has an opening in it which is aligned with the opening located in the second end to allow the fastener to pass through it.

Finally, there is a combination, wherein the hanger described just Supra, is joined with a fastener. The fastener has a head, a pointed tip, and a shaft connecting the head and the tip therebetween, said fastener having threads along the shaft from the head to the pointed tip. The head has a flat upper surface and a flat under surface.

### BRIEF DESCRIPTION OF THE DRAWINGS

FIG. 1 is a full side view of a first embodiment device of this invention.

FIG. 2 is a full front end view in perspective of the first embodiment device of this invention.

FIG. 3 is a full end view of the back end of the first embodiment device of this invention.

FIG. 4 is a full front end view in perspective of a prior art device.

FIG. 5 is a full side view of a fastener of this invention.

FIG. 6 is a full side view of a prior art fastener.

FIG. 7 is a full side view of another embodiment of a prior art device.

FIG. 8 is a full side view of a second embodiment device of this invention.

FIG. 9 is a full side view of a tube that is useful in the second embodiment device of this invention.

FIG. 10 is a full front end view of the device of FIG. 8.

FIG. 11 is a full side view of a third embodiment of this invention.

FIG. 12 is a full front end view of the embodiment of FIG. 11.

### DETAILED DESCRIPTION OF THE DISCLOSURE

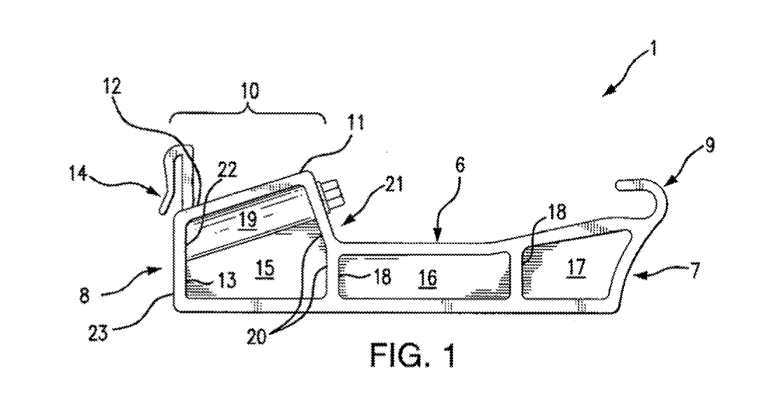

Shown in FIG. 1 of the drawing is a full side view of a first embodiment device 1 of this invention. There is shown the elongated support member 6, having a first end 7 and a second end 8. The first end 7 is configured to engage and hold a front end of a gutter (not shown) for placement on the fascia of a house or other building. The first end 7 is configured as shown as a hook 9.

The device 1 of this invention can be made of plastic, such as polyethylene, or polypropylene, or Polyvinyl chloride or it can be manufactured of metal, for example aluminum or light gage steel. Preferred for this invention is plastic.

The second end 8 is configured as a raised portion 10 that is integrally molded or built into the elongated support member 6. It has an upper surface 11 and a slight extension 12 to the back wall 13. There is a clip 14 attached to the extension 12 for engaging the back edge of a gutter.

As shown, the elongated support member 6 is a solid piece, that is, the walls shown as 15, 16, and 17 and are an integral part of the elongated support member 6, although, this part of the elongated support member 6 could be open with only the braces 18 remaining.

Also shown is a continuous tube 19, that extends from the inside surface 20 of the front wall 21 to the interior surface 22 of the back wall 23. There is an opening 24 through the front wall 21 and this opening 24 is countersunk into the front wall 21 in a bowl shape to accommodate the fastener 2, discussed infra.

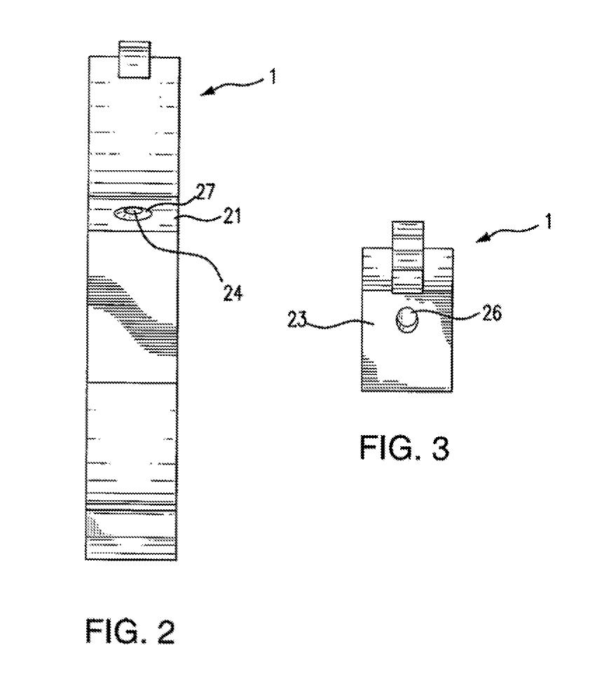

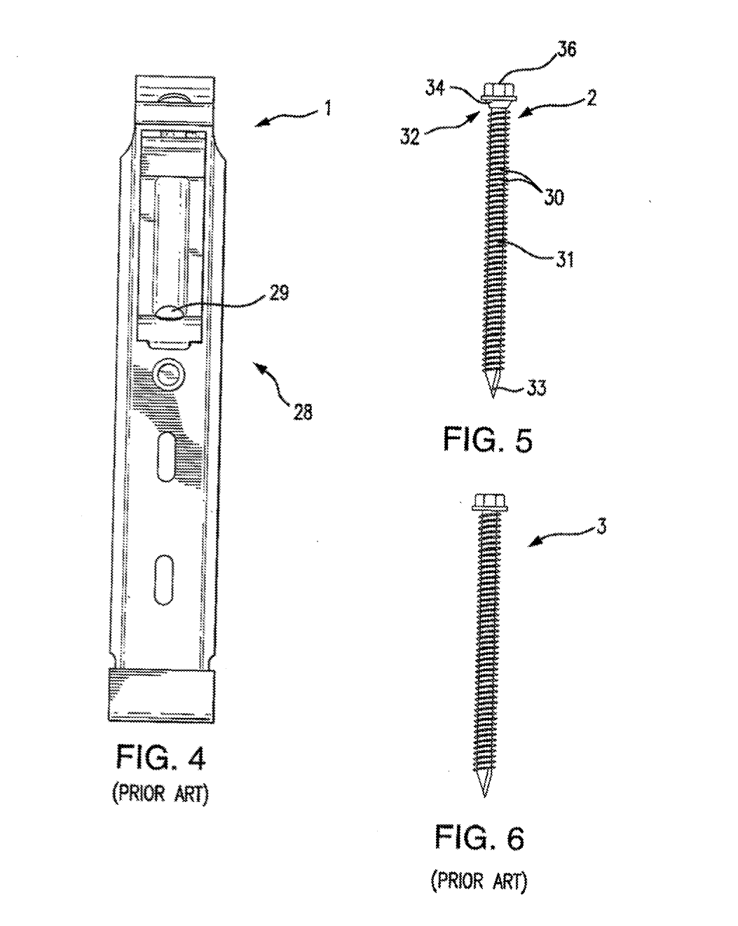

There is also an opening 26 in the back wall 23. This opening is shown in FIG. 3. The countersink 27 and opening 24 are shown in FIG. 2. For comparison purposes, a prior art device 28 is shown in FIG. 4 showing only an opening 29, there being no countersink.

The fastener 2 of this invention is shown in FIG. 5, wherein one can observe the threads 30 of the screw, the long shaft 31 connecting the head 32 and the point 33, and the bowl shaped (dome) 34 underneath the head 32. Also shown is the means 36 by which the fastener 2 can be driven.

For comparison purposes, there is shown a prior art fastener 3 in FIG. 6, and it will be noted that there is no bowl shape underneath the head of the fastener 3.

In use, the fastener 2 is inserted in the opening 24 in the front wall 21 and pushed through until it exits the opening 26 in the back wall 23. When the fastener 2 is driven into the fascia of a board on the eaves of a building, the bowl shape 34 of the fastener 2 fits snugly into the bowl shape of the countersink 27 so that no water can go through the tube. This results in a longer life for the attachment and for the fascia boards as water tends to rust the metals and rot the boards.

Shown in FIG. 8 is a second embodiment of this invention which is a hanger 5 having an elongated support member 37. The elongated support member 37 as shown is not a solid device, but is open, for example, that area designated A in FIG. 8 is open.

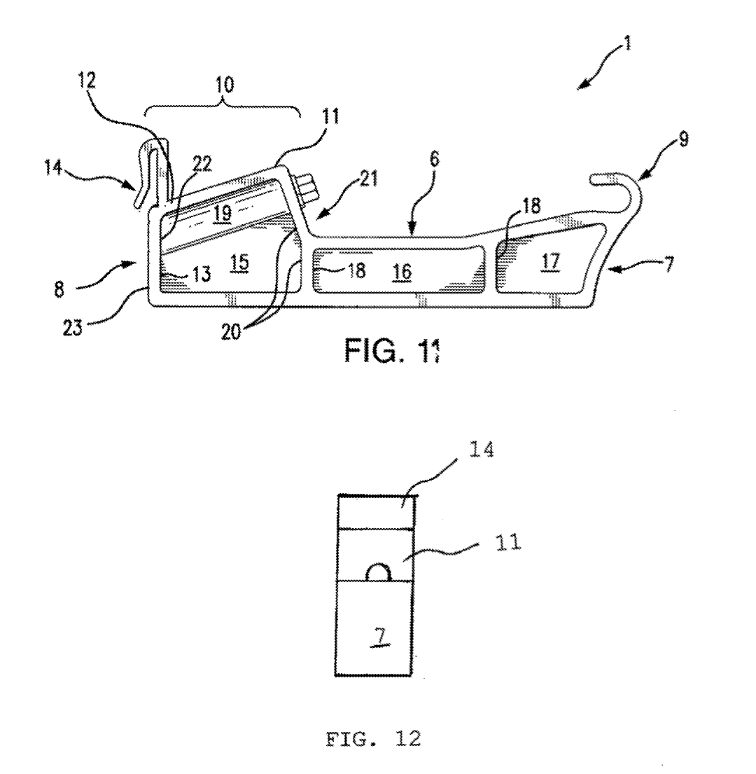

There is a first end 38 and a second end 39 and the first end 38 is configured to engage and hold a front end of a gutter (not shown). It will be noted that the configuration is in the form of a hook 40. The second end 39 is configured as an open raised portion 41 which is integrally connected to a top surface 42 of the elongated support member 37. The raised portion has a front surface 43 which has an opening 44 in it (See FIG. 10).

There is also an opening 45 in the back, wall 46 of the raised portion 41 and an additional opening 49 in the two adjacent walls 47 of the clip 48. Turning still to FIG. 8, there is shown the insertable tube 50 and in FIG. 9, the insertable tube 50 is shown with the rolled ends 51 along with the fastener 3 in phantom.

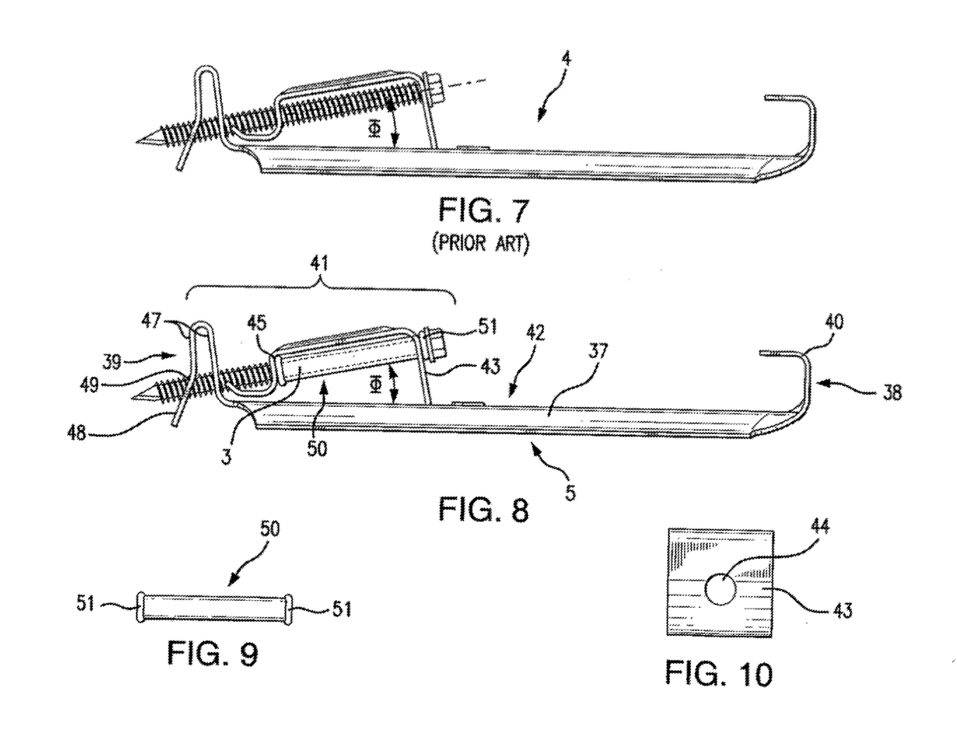

FIG. 7 is a prior art device not showing the insertable tube and the rolled ends of the instant invention.

In a third embodiment, there is shown in FIG. 11 a full side view of a device of this invention in which the clip 25 extends across the entire width of the device as opposed to a partial clip 14 as shown in FIGS. 1, 2, and 3, wherein like numbers have the same meanings as in FIG. 1. FIG. 12 is a full front end view of the device of FIG. 11, showing the front surface 7 of the device, the raised portion 11 at the second end, and the clip 25.

It should be noted by those skilled in the art that the three embodiments of this invention are configured to prevent the passage of water into the internal parts of the devices and to prevent the passage of water to wood fascia, attachment screws, and the like.

What is claimed is:

1. A hanger, said hanger comprising:
i. an elongated support member, said elongated support member having a first end and a second end;
ii. said first end configured to engage and hold a front end of a gutter;
iii. said second end configured as a raised portion, integrally connected to a top surface of said elongated support member;
iv. said raised portion having a front surface having an opening therein,
v. said opening being countersunk, said opening leading to an elongated tube, said elongated tube opening at a back end of said raised portion;
there being a clip surmounted on said back end and extending beyond said raised portion.

2. A fastener, said fastener having a head and a pointed tip, and a shaft connecting said head and said tip therebetween, said fastener having threads along said shaft from said head to said pointed tip, said head having a flat upper surface and a dome shaped under surface.

3. In combination, the hanger of claim 1 and a fastener, said fastener having a head, a pointed tip, and a shaft connecting said head and said tip therebetween, said fastener having threads along said shaft from said head to said pointed tip, said head having a flat upper surface and a dome shaped under surface.

4. A hanger, said hanger comprising
i. an elongated support member, said elongated support member having a first end and a second end;
ii. said first end configured to engage and hold a front end of a gutter;
iii. said second end configured as an open raised portion, integrally connected to a top surface of said elongated support member;
iv. said raised portion having a front surface having an opening therein,
v. an opening aligned with said front wall opening located in said second end;
vi. an insertable tube having both ends thereof rolled, said rolled insertable tube located through said front surface opening and extending outwardly therefrom and said tube extending to said opening in said second end and terminating at an inside wall of said second end;
vii. there being a clip surmounted on said back end and extending beyond said raised portion, said clip having an opening therein aligned with said opening located in said second end to allow said fastener to pass therethrough.

5. In combination, the hanger as claimed in claim 4 and a fastener, said fastener having a head, a pointed tip, and a shaft connecting said head and said tip therebetween, said fastener having threads along said shaft from said head to said pointed tip, said head having a flat upper surface and a flat under surface.
